(19) United States
(12) Patent Application Publication
(10) Pub. No.: US 2008/0310842 A1
(43) Pub. Date: Dec. 18, 2008

(54) DOCSIS COMPATIBLE PON ARCHITECTURE

(76) Inventor: John Skrobko, Berkeley Lake, GA (US)

Correspondence Address: Wm. Brook Lafferty;Scientific-Atlanta, Inc., Intellectual Property Dept. MS 4.3.518, 5030 Sugarloaf Parkway, Lawrenceville, GA, 30044, US

(21) Appl. No.: 11/762,829

(22) Filed: Jun. 14, 2007

(51) Int. Cl. H04J 14/00

(52) U.S. Cl. 398/72

(57) ABSTRACT

In one embodiment, systems for transporting a signal between at least one control point and a user device, comprising a passive optical network operatively coupled to the at least one control point and an optical network termination operatively coupled to the passive optical network and operatively coupled to the user device, wherein the optical network termination comprises an upstream laser and an upstream laser driver coupled to the upstream laser and an upstream laser driver trigger, the upstream laser driver trigger is configured to activate the upstream laser driver and initiate an upstream signal in compliance with Data Over Cable Service Interface Specification (DOCSIS) from the user device to the at least one control point.

### TECHNICAL FIELD

The present disclosure relates generally to signal transmission.

### BACKGROUND

Hybrid fiber-coax (HFC) is a telecommunications industry term for a network used by cable TV operators (also referred to as multiple service operators MSO's) to provide a variety of services, including analog TV, digital TV (standard definition and HDTV), Video On Demand (VOD), switched digital video, telephony, and high-speed data from a home to the headend/hub office, such as control signals to order a movie or internet data to send an email. HFC incorporates both optical fiber along with coaxial cable to create a broadband network. However, HFC networks are structured to be non-symmetrical, meaning that one direction has much more data-carrying capacity than the other direction. Previously, the return-path was only used for some control signals to order movies, or for status monitoring signals that reported the health of RF amplifiers. These applications required very little bandwidth. As additional services have been added to the HFC network, such as internet data and telephony, the return-path is being utilized more heavily.

This issue has led telephone companies (Telcos) to construct a Fiber to the Premises (FTTP) or Fiber of the Home (FTTH) architecture. FTTP is a form of fiber-optic communication delivery in which an optical fiber is run directly to the customers' premises. In FTTP, an optical signal is distributed from the central office over an optical distribution network (ODN), such as a passive optical network (PON). At the endpoints of this network, devices called optical network terminations (ONTs) convert the optical signal into an electrical signal. Likewise, ONTs can supply optical signals that are converted to electrical signals at the central office.

However, PONs are difficult for MSO's to utilize because MSO systems are generally based on DOCSIS (Data Over Cable Service Interface Specifications) for data transmission over HFC networks. DOCSIS, which relies on RF upstream signals, is not compatible with the losses associated with PON architectures.

What is needed is a network architecture for MSO's that utilizes existing HFC DOCSIS communication protocols in a FTTP environment.

### OVERVIEW

Provided are systems for transporting a signal between at least one control point and a user device, comprising a passive optical network operatively coupled to the at least one control point and an optical network termination operatively coupled to the passive optical network and operatively coupled to the user device, wherein the optical network termination comprises an upstream laser and an upstream laser driver coupled to the upstream laser and an upstream laser driver trigger, the upstream laser driver trigger is configured to activate the upstream laser driver and initiate an upstream signal in compliance with Data Over Cable Service Interface Specification (DOCSIS) from the user device to the at least one control point.

Also provided are methods for transporting a signal between at least one control point and a user device, comprising receiving, at an optical network termination, an upstream signal from the user device, triggering an upstream laser, and transmitting an upstream signal through the passive optical network to the at least one control point as a DOCSIS signal.

Further provided is an optical network termination adapted to couple a user device to at least one control point over a passive optical network, comprising an upstream laser and an upstream laser driver trigger coupled to the upstream laser, wherein the upstream laser driver trigger is configured to activate the upstream laser and initiate an upstream signal in compliance with Data Over Cable Service Interface Specification (DOCSIS) from the user device to the at least one control point.

### BRIEF DESCRIPTION OF THE DRAWINGS

The accompanying drawings, which are incorporated in and constitute a part of this specification, illustrate embodiments and together with the description, serve to explain the principles of the methods and systems. Where possible, like numbers represent the same elements throughout the figures:

FIG. 1A illustrates an example PON Architecture;

FIG. 1B illustrates an example PON Architecture;

FIG. 2 illustrates an example PON Architecture comprising RF detection control of upstream signals;

FIG. 3 illustrates an RF detection timing diagram;

FIG. 4 illustrates consequences of collisions in the optical domain.

FIG. 5 illustrates an example PON Architecture comprising RF detection control of upstream signals and an alternative upstream modulation scheme for improved Signal-to-Noise;

FIG. 6 illustrates an example PON upstream path;

FIG. 7 illustrates an example PON Architecture comprising direct upstream laser control and an alternative upstream modulation scheme;

FIG. 8 illustrates an example PON Architecture comprising direct upstream laser control and a digital modulation scheme;

FIG. 9 illustrates direct laser control timing comparison; and

FIG. 10 illustrates an example method.

### DESCRIPTION OF EXAMPLE EMBODIMENTS

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

The present methods and systems may be understood more readily by reference to the following detailed description of preferred embodiments and the Examples included therein and to the Figures and their previous and following description. It is to be understood that both the foregoing general description and the following detailed description are examples and explanatory only and are not restrictive, as claimed.

### I. DOCSIS

Data Over Cable Service Interface Specification (DOCSIS) is an international standard that defines the communications and operation support interface requirements for a data over cable system. DOCSIS permits the addition of high-speed data transfer to an existing Cable TV (CATV) system. DOCSIS is employed by many cable television operators to provide Internet access over their existing hybrid fiber coaxial (HFC) infrastructure.

As frequency allocation band plans differ between US and European CATV systems, DOCSIS standards have been modified for use in Europe. These changes were published under the name of “EuroDOCSIS”. The main differences account for differing TV channel bandwidths; European cable channels conform to PAL TV standards and are 8 MHz wide, whereas in North-America cable channels conform to NTSC standards which specify 6 MHz. The wider bandwidth in EuroDOCSIS architectures permits more bandwidth to be allocated to the downstream data path (taken from a user's point of view, “downstream” is used to download data, while “upstream” is used to upload data). Typically, CPE gear receives “Certification”, while CMTS equipment receives “Qualification”. Japan employs other variants of DOCSIS. As used herein, “DOCSIS” refers to any and all implementations of DOCSIS in any region of the world. All DOCSIS specifications are herein incorporated by reference in their entireties.

DOCSIS provides great variety in options available at Open Systems Interconnection (OSI) layers 1 and 2, the Physical (PHY) and Media Access Control (MAC) layers.

At the physical layer DOCSIS 1.0/1.1 specified channel widths between 200 kHz and 3.2 MHz. DOCSIS 2.0 specifies 6.4 MHz, but is backward compatible to the earlier, narrower channel widths. DOCSIS 1.0/1.1/2.0 specifies that 64-level or 256-level QAM (64-QAM or 256-QAM) be used for modulation of downstream data, and QPSK or 16-level QAM (16-QAM) be used for upstream modulation. DOCSIS 2.0 specifies 32-QAM, 64-QAM and 128-QAM also be available for upstream use.

At the MAC layer, DOCSIS employs a mixture of deterministic access methods, specifically TDMA for DOCSIS 1.0/1.1 and both TDMA and S-CDMA for DOCSIS 2.0, with a limited use of contention for bandwidth requests. In contrast to the pure contention-based MAC CSMA/CD employed in Ethernet systems, DOCSIS systems experience few collisions. For DOCSIS 1.1 and above the MAC layer also includes extensive Quality of Service (QoS) features that help to efficiently support applications, for example Voice over IP, that have specific traffic requirements, such as low latency.

All of these features combined enable a total upstream throughput of 30.72 Mbit/s per channel (although the upstream speed in DOCSIS 1.0 and 1.1 is limited to 10.24 Mbit/s). The DOCSIS standard supports a downstream throughput of up to 42.88 Mbit/s per channel with 256-QAM (owing to 8 MHz channel width, the EuroDOCSIS standard supports downstream throughput of up to 57.20 Mbit/s per channel).

DOCSIS 3.0 features IPv6 and channel bonding, which enables multiple downstream and upstream channels to be used together at the same time by a single subscriber.

TABLE I
Synchronization speed (Usable speed)

| DOCSIS Version | Downstream | | Upstream | |
|---|---|---|---|---|
| 1.x | 42.88 (38) | Mbit/s | 10.24 (9) | Mbit/s |
| Euro | 57.20 (51) | Mbit/s | 10.24 (9) | Mbit/s |
| 2.0 | 42.88 (38) | Mbit/s | 30.72 (27) | Mbit/s |
| 3.0 | +160 | Mbit/s | +120 | Mbit/s |

A DOCSIS architecture comprises two components: a cable modem (CM) located at the customer premises, and a cable modem termination system (CMTS) located at a control point. As used herein, a control point can be, for example, a CATV headend, a hub, service office, and the like.

A typical CMTS is a device which hosts downstream and upstream ports (it is functionally similar to the DSLAM used in DSL systems). For duplex communication between a CMTS and CM, two physical ports are required (unlike Ethernet, where one port provides duplex communications). Because of the noise in the return (upstream) path, a CMTS has more upstream ports than downstream ports—the additional upstream ports provide ways of minimizing noisy lines (until DOCSIS 2.0, they were required to provide higher upstream speeds as well).

HFC is a telecommunications industry term for a network which incorporates both optical fiber along with coaxial cable to create a broadband network. The fiber optic network extends from the cable operators' master headend, sometimes to regional headends, and out to a neighborhood's hubsite, and finally to a fiber optic node which serves anywhere from 25 to 2000 homes. A master headend or central office will usually have satellite dishes for reception of distant video signals as well as IP aggregation routers. Some master headends also house telephony equipment for providing telecommunications services to the community. A regional or area headend will receive the video signal from the master headend and add to it the Public, Educational and/or Governmental (PEG) channels as required by local franchising authorities or insert targeted advertising that would appeal to a local area.

A customer personal computer (PC) and associated peripherals are termed Customer-premises equipment (CPE). The CPE are connected to the cable modem, which is in turn connected through the HFC network to the CMTS. The CMTS then routes traffic between the HFC and the Internet. Using the CMTS, the cable operator (or Multiple Service Operators—MSO) exercises full control over the cable modem's configuration; the CM configuration is changed to adjust for varying line conditions and customer service requirements.

DOCSIS cable modems have caps (restrictions) on upload and download rates. These are set by transferring a configuration file to the modem, via TFTP (Trivial File Transfer Protocol), when the modem first establishes a connection to the provider's equipment.

One downstream channel can handle hundreds of cable modems. As the system grows, the CMTS can be upgraded with more downstream and upstream ports. If the HFC network is vast, the CMTS can be grouped into hubs for efficient management.

### II. FTTP

Fiber to the premises (FTTP) is a form of fiber-optic communication delivery in which an optical fiber is run directly to the customers' premises. This contrasts with other fiber-optic communication delivery strategies such as fiber to the node (FTTN), fiber to the curb (FTTC), or HFC, all of which depend upon more traditional methods such as copper wires or coaxial cable for “last mile” delivery.

Fiber to the premises can be further categorized according to where the optical fiber ends: FTTH (fiber to the home) is a form of fiber optic communication delivery in which the optical signal reaches the end user's living or office space and FTTB (fiber to the building, also called fiber to the basement) is a form of fiber optic communication delivery in which the optical signal reaches the premises but stops short of the end user's living or office space.

In FTTP, an optical signal is distributed from the central office over an optical distribution network (ODN). At the endpoints of this network, devices called optical network terminations (ONTs) convert the downstream optical signal into an electrical signal. The signal usually travels electrically between the ONT and the end-users' devices.

Optical distribution networks have several competing technologies. The simplest optical distribution network can be called direct fiber. In this architecture, each fiber leaving the central office goes to exactly one customer. More commonly each fiber leaving the central office is actually shared by many customers. It is not until such a fiber gets relatively close to the customers that it is split into individual customer-specific fibers. There are two competing optical distribution network architectures which achieve this split: active optical networks (AONs) and passive optical networks (PONs).

Active optical networks rely on electrically powered equipment to distribute the signal, such as a switch, router, or multiplexer. Each signal leaving the central office is directed only to the customer for which it is intended. Incoming signals from the customers avoid colliding at the intersection because the powered equipment there provides buffering.

Passive optical networks do not use electrically powered components to split the signal. Instead, the signal is distributed using beam splitters. Each splitter typically splits a single fiber into 16, 32, or 64 fibers, depending on the manufacturer, and several splitters can be aggregated in a single cabinet. A beam splitter cannot provide any switching or buffering capabilities; the resulting connection is called a point-to-multipoint link. For such a connection, the optical network terminations on the customer's end must perform some special functions which would not otherwise be required. For example, due to the absence of switching capabilities, each signal leaving the central office must be broadcast to all users served by that splitter (including to those for whom the signal is not intended). It is therefore up to the optical network termination to filter out any signals intended for other customers.

In addition, since beam splitters cannot perform buffering, each individual optical network termination must be coordinated in a multiplexing scheme to prevent signals leaving the customer from colliding at the intersection. Two types of multiplexing are possible for achieving this: wavelength-division multiplexing (WDM) and time-division multiplexing. With wavelength-division multiplexing, each customer transmits their signal using a unique wavelength. With time-division multiplexing, the customers “take turns” transmitting information.

In comparison with active optical networks, passive optical networks have significant advantages and disadvantages. They avoid the complexities involved in keeping electronic equipment operating outdoors. They also allow for analog broadcasts, which can simplify the delivery of analog television. However, because each signal must be pushed out to everyone served by the splitter (rather than to just a single switching device), the central office must be equipped with powerful transmission equipment. In addition, because each customer's optical network termination must transmit all the way to the central office (rather than to just the nearest switching device), customers can't be as far from the central office as is possible with active optical networks.

A passive optical network (PON) is a point-to-multipoint, fiber to the premises network architecture in which un-powered optical splitters are used to enable a single optical fiber to serve multiple premises, typically 32. A PON can comprise an Optical Line Terminal (OLT) at the service provider's central office and a number of Optical Network Terminations (ONTs) near end users.

Upstream signals are combined using a multiple access protocol, invariably time division multiple access (TDMA). The OLTs “range” the ONTs in order to provide time slot assignments for upstream communication.

A PON takes advantage of wavelength division multiplexing (WDM), using one wavelength for downstream traffic and another for upstream traffic on a single fiber. As with bit rate, the standards describe several optical budgets, but the industry has converged on 28 dB of loss budget. This corresponds to about 20 km with a 32-way split (7 dB fiber, 18 dB splitter, 1 dB wdm, 2 dB connectors).

A PON can comprise an OLT, one or more user nodes, called optical network terminations (ONTs), and the fibers and splitters between them, called the optical distribution network (ODN). The OLT provides the interface between the PON and the backbone network. The ONT terminates the PON and presents the native service interfaces to the user. These services can comprise voice (plain old telephone service (POTS) or voice over IP—VoIP), data (typically Ethernet or V.35), video, and/or telemetry (TTL, ECL, RS530, etc.). A PON is a converged network, in that all of these services are typically converted and encapsulated in a single packet type for transmission over the PON fiber.

The OLT is responsible for allocating upstream bandwidth to the ONTs. Because the ODN is shared, ONT upstream transmissions can collide if they were transmitted at random times. ONTs can lie at varying distances from the OLT, meaning that the transmission delay from each ONT is unique. The OLT measures delay and sets a register in each ONT via PLOAM (physical layer operations and maintenance) messages to equalize its delay with respect to all of the other ONTs on the PON. Once the delay of all ONTs has been set, the OLT transmits so-called grants to the individual ONTs. A grant is permission to use a defined interval of time for upstream transmission. The grant map is dynamically re-calculated every few milliseconds. The map allocates bandwidth to all ONTs, such that each ONT receives timely bandwidth for its service needs.

Some services—POTS, for example—require essentially constant upstream bandwidth, and the OLT may provide a fixed bandwidth allocation to each such service that has been provisioned. DS1 and some classes of data service may also require constant upstream bit rate. But much data traffic—internet surfing, for example—is bursty and highly variable. Through dynamic bandwidth allocation (DBA), a PON can be oversubscribed for upstream traffic, according to the traffic engineering concepts of statistical multiplexing. (Downstream traffic can also be oversubscribed, in the same way that any LAN can be oversubscribed. The only special feature in the PON architecture for downstream oversubscription is the fact that the ONT must be able to accept completely arbitrary downstream time slots, both in time and in size.)

Once at an end user, the signal typically travels the final distance to the end user's equipment using an electrical format. An optical network termination converts the optical signal into an electrical signal. In one embodiment, optical network terminations use thin film filter technology (or more recently dispersion bridge planar lightwave circuit technology) to convert between optical and electrical signals.

### III. Systems

Provided are operating environments that are only examples of operating environments and are not intended to suggest any limitation as to the scope of use or functionality of operating environment architecture. Neither should the operating environments be interpreted as having any dependency or requirement relating to any one or combination of components illustrated in the example operating environments. The systems provide a migration path for CATV operators to PON architectures that can controls ingress on the upstream path and allow monitoring and control at the home.

Comparison of specifications among alternative PON concepts can be misleading. Consider the following table, Table II, which compares data throughput of four PON concepts:

TABLE II

| | Downstream | Upstream |
|---|---|---|
| GEPON | 1 Gbps/32 ONTs | 1 Gbps/32 ONTs |
| | (31 Mbps/sub) | (31 Mbps/sub) |
| GPON | 2488 Mbps/32 ONTs | 1244 Mpbs/32 ONTs |
| | (78 Mbps/sub) | (39 Mbps/sub) |
| BPON | 622 Mbps/32 ONTs | 155 Mbps/32 ONTs |

What is not apparent is how the data is being used. In GPON and GEPON, the intent is to use the data path to deliver video, voice, and data (IPVideo for example). The BPON uses a broadcast overlay, but targeted services will be supplied in a digital format. Only a DOCSIS approach combines the HFC targeted services model to supply downstream video. Therefore, a DOCSIS PON can compete with traditional FTTP architectures, especially since the DOCSIS infrastructure already exists.

One approach is to build service area hubs using a 32 home PON. The presently accepted HFC targeted services hub generally serves less than 200 homes. Four 32 home PONS combine to make a 128 home service area. The following list has example assumptions used for system calculations:
The PON link can serve 128 homes (present HFC target is <200 homes per transmitter). So, transmitters, receivers, and CMTSs are located in hubs.
Fiber plus splice loss from hub to home <6 dB at 1310 nm (15 km).
Downstream channel plan can support standard 78 Analog/75 Digital channels.
Data and voice can be provided by standard DOCSIS with VoIP.

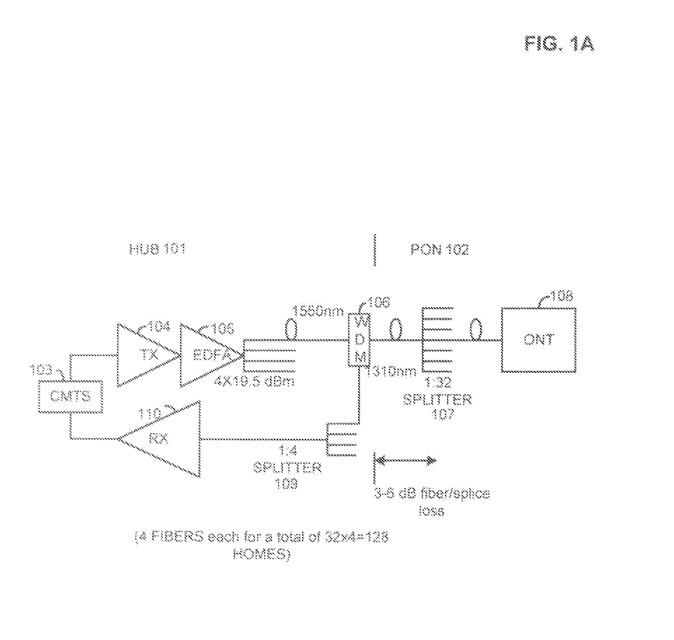

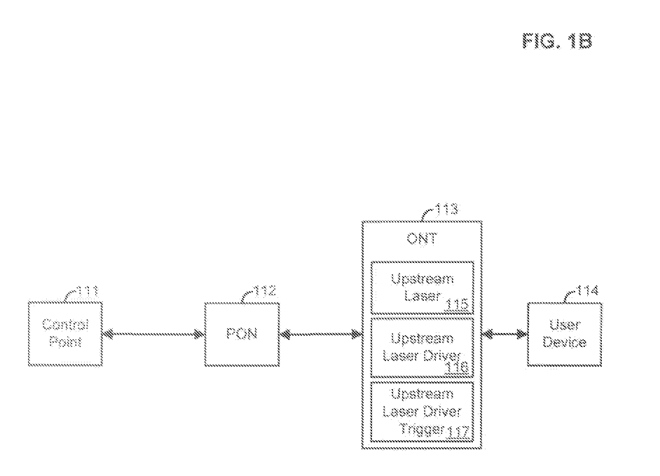

One embodiment of the resulting architecture is illustrated in FIG. 1A. The system can comprise a hub 101, also referred to as a control point, coupled to a PON 102 which can be coupled to an optical network termination 108. The system can further comprise a cable modem termination system (CMTS) 103 at the control point to provide high speed data services, such as Cable Internet or Voice over IP, to cable subscribers. The CMTS 103 can be coupled to optical transmitter 104. Optical transmitter 104 can accept an electrical signal as input, process the signal, and use it to modulate an opto-electronic device, such as a laser. Optical transmitter 104 can be coupled to an optical amplifier 105 such as an Erbium Doped Fiber Amplifier (EDFA 105). The EDFA 105 can boost an optical signal. By way of example, EDFA 105 can comprise several meters of glass fiber doped with erbium ions. When the erbium ions are excited to a high energy state, the doped fiber changes from a passive medium to an active amplifying medium. Optical fiber can be split after the EDFA 105 to service a plurality of end users. The signal traveling down the optical fiber can have a wavelength, for example, of 1550 nm. The system can further comprise a wavelength division multiplexer (WDM) 106. The WDM 106 allows for the transmission of two or more signals by sending the signals at different wavelengths through the same fiber. The system can be coupled to a PON 102, which can comprise a splitter 107 to service a further plurality of end users. Each fiber leaving the splitter 107 can be coupled to an optical network termination, such as ONT 108. The ONT 108 can be configured for receiving a signal from the CMTS 103 and sending the signal to an end user. The ONT 108 can be further configured to receive a signal from the end user and send the signal to the CMTS 103. In the latter case, the signal from the end user can pass from the ONT 108 through the splitter 107 and into the WDM 106 where the signal can be passed to splitter 109 and to an optical receiver 110. The signal traveling up the optical fiber can have a wavelength, for example, of 1310 nm. Optical receiver 110 can detect an optical signal, convert it to an electrical signal, and pass the signal on to CMTS 103.

In another embodiment, illustrated in FIG. 1B, provided is a system for transporting a signal between at least one control point 111 and a user device 114, comprising a passive optical network 112 operatively coupled to the at least one control point 111 and an optical network termination 113 operatively coupled to the passive optical network 112 and operatively coupled to the user device 114, wherein the optical network termination 113 comprises an upstream laser 115 and an upstream laser driver 116 coupled to the upstream laser 115, an upstream laser driver trigger 117, the upstream laser driver trigger 117 is configured to activate the upstream laser driver 116 and initiate an upstream signal in compliance with Data Over Cable Service Interface Specification (DOCSIS) from the user device 114 to the at least one control point 111.

In one embodiment the user device 114 can be a cable modem and the upstream laser driver trigger 117 can be an RF detector. The upstream laser driver trigger 117 can comprise an RF detector configured to detect an incoming upstream electrical signal from the user device 114 and activate the upstream laser driver 116.

In another embodiment, the upstream laser driver trigger 117 can be a cable modem. The cable modem can optionally be in the optical network termination 113. The upstream laser driver trigger 117 can comprise a signal from a cable modem configured to activate the upstream laser driver.

The system can be configured to utilize a modulation scheme that allows reception in a low signal-to-noise environment. The modulation scheme can be, for example, forms of frequency modulation (FM), phase modulation (PM), or digital modulation as are known in the art.

In one embodiment, the user device 114 can comprise a Digital Audio Visual Council (DAVIC) signal generator coupled to a single wire return device (SWRD) coupled to a cable modem, wherein a DAVIC signal is transmitted to the SWRD, converted into a data signal, transmitted to the cable modem, and sent upstream to the at least one control point 111. In one embodiment, the DAVIC signal generator can be a set-top box. DAVIC is described as an example of a proprietary communication standard for use by a set-top box. In various embodiments, any type of proprietary signal generator can be used and transmitted to a SWRD configured to process the particular proprietary signal. The proprietary signal can be any signal that conforms to transmission protocols such as those protocols established by the Society of Cable Telecommunications Engineers (SCTE), e.g., SCTE-55, more specifically SCTE 55-1 and SCTE 55-2, herein incorporated by reference in their entirety.

In another embodiment, the user device 114 can comprise a set-top box coupled to a cable modem, wherein a data signal is transmitted to the cable modem and sent upstream to the at least one control point 111. The data signal can be, for example, an Ethernet signal, as are known in the art.

The signal transported between at least one control point 111 and a user device 114 can be comprised of at least one of a video signal, a voice signal, and a data signal. The signal can be a downstream signal and the at least one control point 111 can transmit the downstream signal optically. The signal can be an upstream signal and the user device 114 can transmit the upstream signal to the control point 111 according to the Data Over Cable Service Interface Specification (DOCSIS). The user device 114 can be contained within the optical network termination 113.

A. RF Detector Architecture

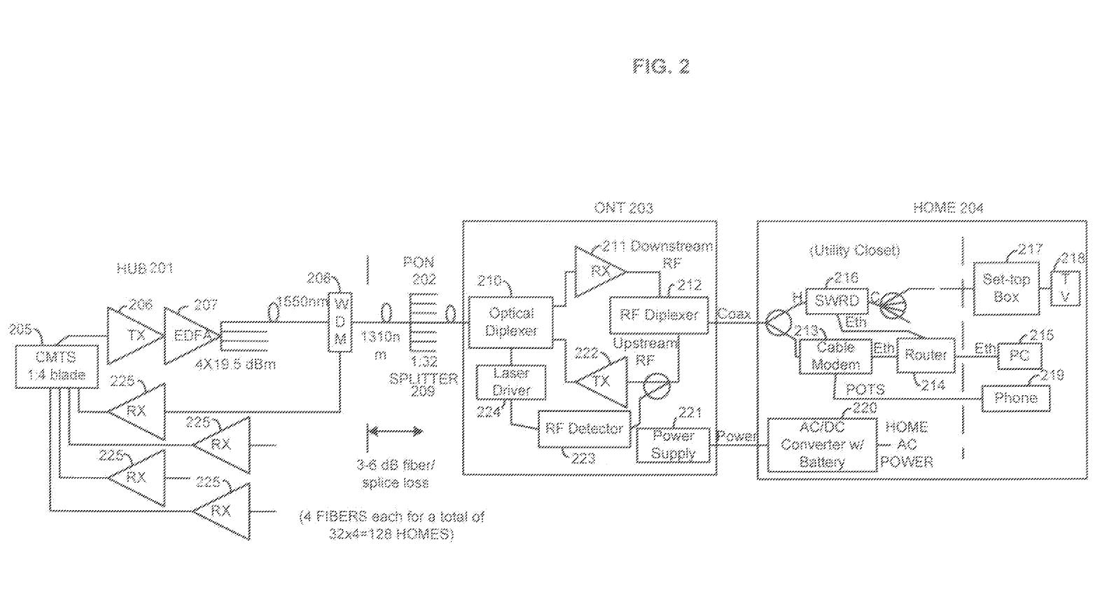

In one embodiment, illustrated in FIG. 2, provided is an embodiment of a system for transporting a signal between a control point and a user device that can utilize an RF detector to trigger a laser in an optical network termination. Where possible, like numbers represent the same elements throughout the figures. Components in common with FIG. 1 that have been previously described will not be described in detail as they relate to FIG. 2. The example system of FIG. 2 can support one upstream 6.4 MHz 16 QAM channel (17 Mbps/32 Homes) and serve PON splits of up to 32 homes. The system of this embodiment can comprise a CMTS 205, such as 1:4 CMTS blade 205. A 1:4 CMTS blade 205 allows for receiving four signals and transmitting one signal. The system can further comprise an optical transmitter 206 and an optical amplifier 207, such as a four port TX/EDFA module with 18.3 dBm minimum output. The system can further comprise a WDM 208 coupled to the optical amplifier 207 and a PON 202 which can comprise splitter 209. Splitter 209 can be coupled to an optical diplexer 210. In the example system, downstream and upstream optical signals can be carried over the same fiber. The wavelengths of these two signals can be the same or different. Using different wavelengths for the downstream and upstream signals reduces the total optical loss of the PON and for this reason it is the most commonly used technique. By way of example, the downstream wavelength can be 1550 nm and the upstream wavelength can be 1310 nm. The signals can be inserted or extracted from the fiber using a course wavelength division multiplexer (CWDM) filter. An optical diplexer 210 can comprise a laser, a photodiode, and the CWDM filter into a single package. Optical diplexer 210 can be coupled to optical receiver 211, the combination of which can detect the optical signal, convert it to an electrical signal, and pass the signal on to RF diplexer 212.

RF diplexer 212 can pass the signal along, for example, to a coaxial connection into a home 204. The coaxial connection can be split and directed toward a plurality of end user devices. For example, the coaxial connection can be to a cable modem 213. Cable modem 213 can connect an end user PC to the Internet. Cable modem 213 can optionally be coupled to a router 214 for directing an Internet connection to a plurality of end user devices, including personal computer (PC) 215. The router can be wired or wireless.

The coaxial connection can also be to a Single Wire Return Device (SWRD) 216. SWRD 216 allows signals to pass through to a plurality of end user devices such as DAVIC Return Set-top Box 217. DAVIC Return Set-top Box 217 can process an incoming signal, such as an audio/video signal, and provide it to television (TV) 218. DAVIC Return Set-top Box 217 can also send an upstream signal, such as a request for a Video on Demand (VOD), to the SWRD 216. SWRD 216 is a data conversion device that can receive a Digital Audio Video Council (DAVIC) compliant signal, process the DAVIC compliant signal into an IP packet, and forward the IP packet onto an Ethernet network to router 214 which can send the signal upstream through cable modem 213. Alternatively, the SWRD 216 can be coupled directly to the cable modem 213. Current FTTP architectures require a set-top box to send upstream communication via Ethernet transport. The SWRD 216 eliminates the need for an Ethernet port on the set-top box 217 by allowing the set-top box to communicate upstream using traditional QPSK RF transmission. Alternatively, the set-top box 217 can comprise an Ethernet port and be coupled directly to the router 214 or the cable modem 213.

The set-top box 217 can have any alternate RF upstream standard, and in this case, the SWRD would be compatible with that alternate standard.

Additionally, telephone service can be provided by coupling a telephone 219 via a Plain Old Telephone System (POTS) or via a Voice Over IP (VOIP) system.

The ONT 203 can derive power from the home 204. Alternatively, it can be network powered through a separate outdoor power feed. In either case, battery backup can be used to power emergency telephone service during a power outage. In this example, the cable modem 213 can have battery backup power to maintain the POTS connection.

A signal can be sent upstream from the cable modem 213 through the coaxial connection to the RF Diplexer 212. The RF Diplexer 212 can then pass the signal to an optical transmitter 222 that can accept an electrical signal as input, process the signal, and use it to modulate an opto-electronic device, such as a laser contained within the optical diplexer 210. However, to avoid upstream collisions the laser can be placed under indirect control of the cable modem 213 by coupling an RF Detector 223 to the upstream RF connection between the RF Diplexer 212 and optical transmitter 222. Activation of the upstream laser relies on the RF detector 223 recognizing a burst signal output from the cable modem 213 activating the upstream laser via laser driver 224 in response. Thus, the optical system is placed under the indirect control of a DOCSIS compliant system, such as CMTS 205 and cable modem 213. In a DOCSIS network, the CMTS controls the timing and rate of most upstream transmissions that cable modems make, thus utilizing existing DOCSIS protocols to control upstream optical transmissions, minimizing upstream collisions. The upstream signal can be received by the WDM 208 and sent to an optical receiver, such as optical receivers 225. By way of example, the Carrier to Noise Ratio (CNR) can be 48 dB downstream and 30.3 dB upstream.

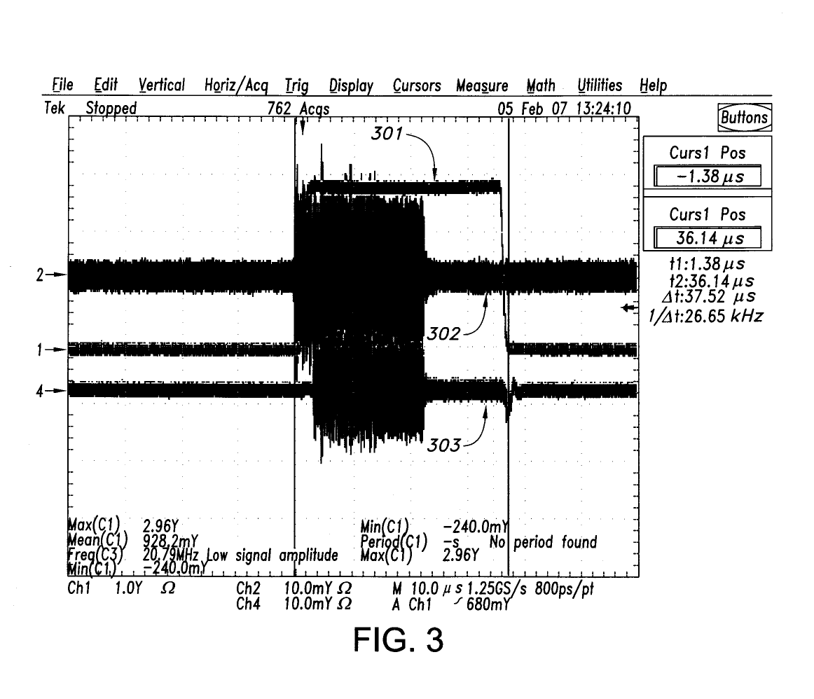

FIG. 3 illustrates a simulated RF detection scenario. An RF switch was used to represent the gating of a laser driver and laser. The input signal to the RF detector is shown as a burst 302. The detector output 301 is used to trigger the RF switch (laser driver). The detection process introduces a slight delay, demonstrated by the delayed risetime of the trigger signal 301. The RF switch (laser) output 303 is thereby delayed with a portion of the signal preamble lost. Typical burst signals contain adequate preamble, and in the case of DOCSIS, a programmable preamble length, to prevent loss of information due to this delay.

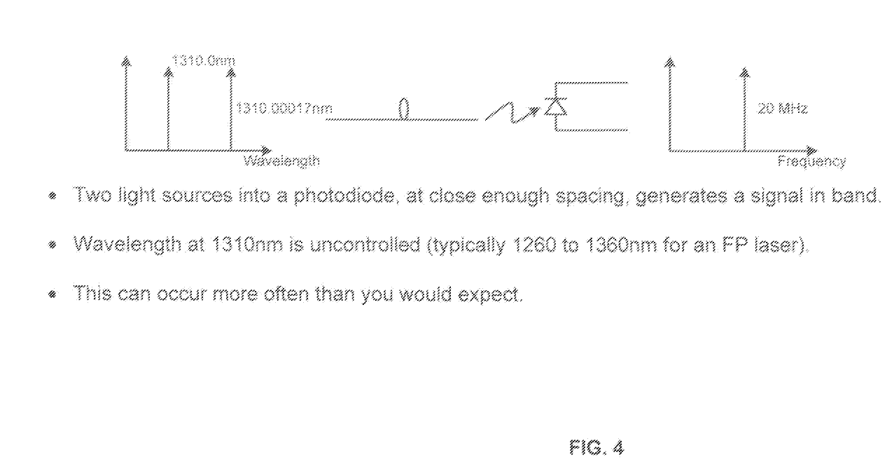

As illustrated in FIG. 4, the use of an RF detector can be susceptible to false triggering due to ingress, or triggering from other sources in the home such as a DAVIC settop. Both possibilities can cause optical collisions in the PON, which is not desirable. In cases where two or more lasers output at wavelengths within several hundred MHz of each other, beats will be generated in the RF band, overdriving and/or jamming the desired signal. Control of the laser wavelengths to prevent this is not considered practical.

B. RF Detector Architecture with Modulation Scheme for Upstream Transmission

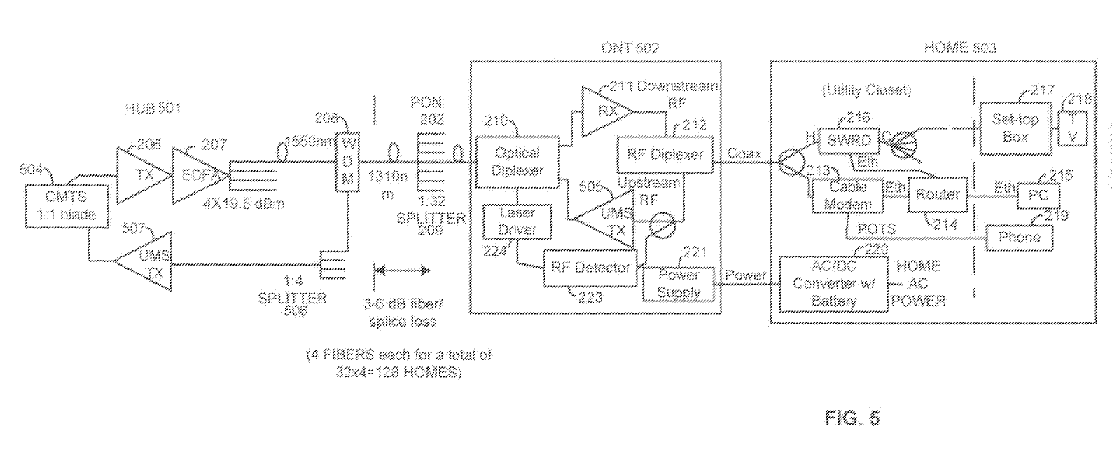

In another embodiment, illustrated in FIG. 5, provided is an example system for transporting a signal between a control point and a user device that can utilize an alternative upstream modulation scheme (UMS) to overcome excessive losses in the upstream optical path. Where possible, like numbers represent the same elements throughout the figures. Components in common with FIG. 1A, FIG. 1B and FIG. 2 that have been previously described will not be described in detail as they relate to FIG. 5. The example system can support four upstream 6.4 MHz 64 QAM channels (104 Mbps/128 Homes) and can serves PON splits up to 32 homes.

The example system can comprise a hub 501 that can comprise a CMTS 504, such as 1:1 CMTS blade 504. A 1:1 CMTS blade 504 allows for receiving one signal and transmitting one signal. The system can comprise an optical transmitter 206 and an optical amplifier 207, such as a four port TX/EDFA module with 18.3 dBm minimum output. The system can further comprise a WDM 208 coupled to the optical amplifier 207 and a PON 202 which can comprise splitter 209. Splitter 209 can be coupled to an optical diplexer 210. In the example system, downstream and upstream optical signals can be carried over the same fiber. An ONT 502 can comprise an optical diplexer. An optical diplexer 210 can comprise a laser, a photodiode, and a CWDM filter. Optical diplexer 210 can be coupled to optical receiver 211, the combination of which can detect the optical signal, convert it to an electrical signal, and pass the signal on to RF diplexer 212.

RF diplexer 212 can pass the signal along, for example, a coaxial connection into a home 503. The coaxial connection can be split and directed toward a plurality of end user devices. For example, the coaxial connection can be to a cable modem 213. Cable modem 213 can connect an end user PC to the Internet. Cable modem 213 can optionally be coupled to a router 214 for directing an Internet connection to a plurality of end user devices, including personal computer (PC) 215. The router can be wired or wireless.

The coaxial connection can also be to a Single Wire Return Device (SWRD) 216. SWRD 216 allows signals to pass through to a plurality of end user devices such as DAVIC Return Set-top Box 217. DAVIC Return Set-top Box 217 can process an incoming signal, such as an audio/video signal, and provide it to television (TV) 218. DAVIC Return Set-top Box 217 can also send an upstream signal, such as a request for a Video on Demand (VOD), to the SWRD 216. SWRD 216 is a data conversion device that can receive a Digital Audio Video Council (DAVIC) compliant signal, process the DAVIC compliant signal into an IP packet, and forward the IP packet onto an Ethernet network to router 214 which can send the signal upstream through cable modem 213. Alternatively, the SWRD 216 can be coupled directly to the cable modem 213. Alternatively, the set-top box 217 can comprise an Ethernet port and be coupled directly to the router 214 or the cable modem 213.

The set-top box 217 can have any alternate RF upstream standard, and in this case, the SWRD 216 would be compatible with that alternate standard.

Additionally, telephone service can be provided by coupling a telephone 219 via a Plan Old Telephone System (POTS) or via a Voice Over IP (VOIP) system.

The ONT 502 can derive power from the home 503. Alternatively, it can be network powered through a separate outdoor power feed. In either case, battery backup can be used to power emergency telephone service during a power outage. In this example, the cable modem 213 can have battery backup power to maintain the POTS connection.

A signal can be sent from the cable modem 213 through the coaxial connection to the RF Diplexer 212. The RF Diplexer 212 can then pass the signal to a UMS optical transmitter 505 that can accept an electrical signal as input, process the signal, and use it to modulate an opto-electronic device, such as a laser contained within the optical diplexer 210. However, to avoid upstream collisions the laser can be placed under indirect control of the cable modem 213 by coupling an RF Detector 223 to the upstream RF connection between the RF Diplexer 212 and UMS optical transmitter 505. Activation of the upstream laser relies on the RF detector 223 recognizing a burst signal output from the cable modem 213 activating the upstream laser via laser driver 224 in response. Thus, the optical system is placed under the indirect control of a DOCSIS compliant system, such as CMTS 504 and cable modem 213. The upstream signal can be received by the WDM 208 and sent to an optical receiver such as UMS optical receiver 507, through a splitter such as splitter 506. By way of example, the Carrier to Noise Ratio (CNR) can be 48 dB downstream and >34 dB upstream.

UMS transmitter 505 and UMS receiver 507 can utilize a distributed feedback laser (DFB). A DFB laser is a type of laser diode where the active region of the device is structured as a diffraction grating. The grating, known as a distributed Bragg reflector, provides optical feedback for the laser due to Bragg scattering from the structure. Since the grating provides feedback, DFB lasers do not use discrete mirrors to form the optical cavity (as are used in conventional laser designs). The grating is constructed so as to reflect only a narrow band of wavelengths, and thus produce a narrow linewidth of laser output.

Upstream Carrier to Noise (CNR) performance can be limited by many parameters, including: Laser Output Power, Laser Slope Efficiency, Laser RIN, RF channel loading (number of channels, channel bandwidth), Optical Modulation Index (OMI), OMI tolerance (factory setup, temperature drift), Optical Link loss (fiber and splitter loss), DOCSIS CMTS AGC tolerance, Optical Receiver Noise Current, and Optical Receiver Photodiode Responsivity.

Typical HFC architectures use point to point upstream links and therefore have little optical loss. PON architectures, on the other hand, have additional splitter loss on the order of 18 dB, which greatly reduces the CNR. Required CNR is set by the choice of modulation and desired bit error ratio (BER). As a result, traditional amplitude modulated analog optical links are inadequate for PONs when transporting multiple high order modulation signals. The example system can use a modulation scheme that allows reception of a signal in a low signal-to-noise environment. The system can use, for example, frequency modulation of the entire upstream RF band. The disclosed systems can utilize the methods and systems disclosed in U.S. patent application Ser. No. 11/683,640, filed on Mar. 8, 2007, entitled “Reverse Path Optical Link Using Frequency Modulation”, herein incorporated by reference in its entirety.

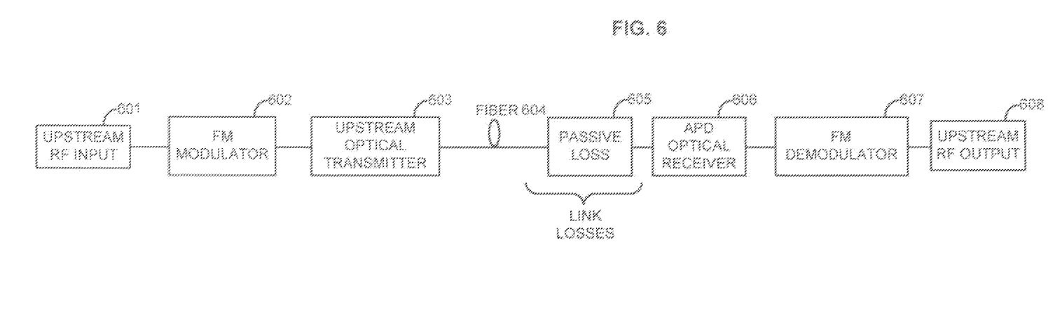

FIG. 6 illustrates the upstream path of the PON. The input RF signal 601 is contained in the 5-42 MHz band, regulated by DOCSIS. A portion, or the entire band can be used as input to an FM modulator 602, which operates at a higher frequency chosen to support this wideband input and appropriate for the subsequent optical link. This FM signal can then be input to an optical transmitter 603. Fiber 604 and passive loss 605 represent the optical losses of the PON. The receiver 606 can be a PIN or APD diode, depending on overall link losses, to convert the optical signal to an electrical signal. This RF signal is input to an FM demodulator 607 which outputs the original 5-42 MHz upstream band 608.

C. Modem Control Architecture with either Modulation Scheme or Digital Upstream Transmission

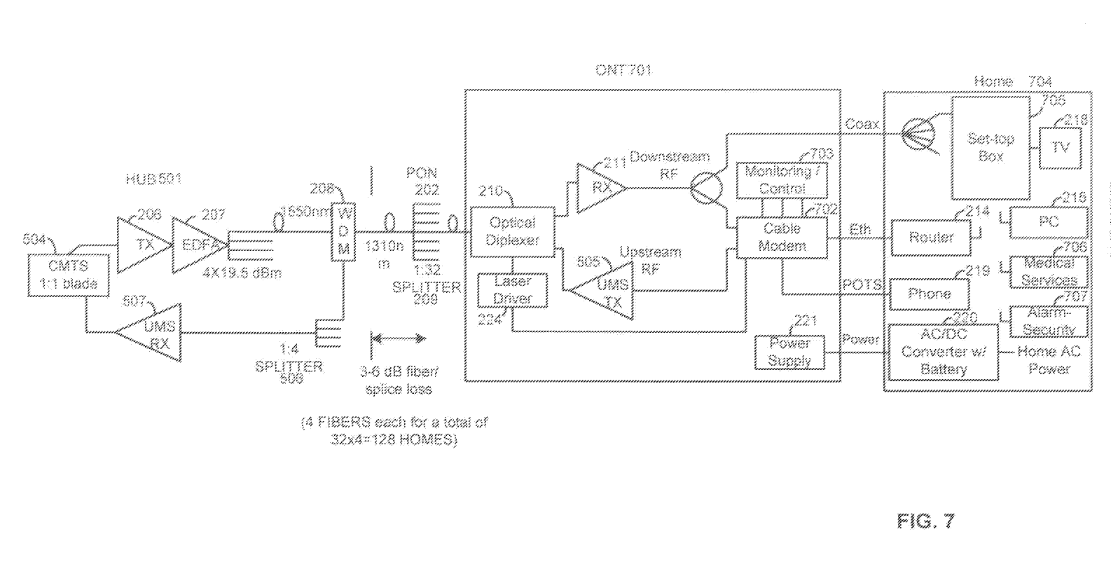

In another embodiment, illustrated in FIG. 7, provided is an example system for transporting a signal between a control point and a user device that utilizes direct control of an upstream laser by a DOCSIS system. The ONT of the example system can comprise a DOCSIS modem to provide direct control of the upstream laser. Presence of the modem also permits cost effective monitoring of the optics and control over the video output. Where possible, like numbers represent the same elements throughout the figures. Components in common with FIG. 1A, FIG. 1B, FIG. 2, and FIG. 5 that have been previously described will not be described in detail as they relate to FIG. 7.

The example system can comprise a hub 501 which can comprise a CMTS 504, such as 1:1 CMTS blade 504. A 1:1 CMTS blade 504 allows for receiving one signal and transmitting one signal. The system can comprise an optical transmitter 206 and an optical amplifier 207, such as a four port TX/EDFA module with 18.3 dBm minimum output. The system can further comprise a WDM 208 coupled to the optical amplifier 207 and a PON 202 which can comprise splitter 209. Splitter 209 can be coupled to an optical diplexer 210. In the example system, downstream and upstream optical signals can be carried over the same fiber. An ONT 701 can comprise an optical diplexer. An optical diplexer 210 can comprise a laser, a photodiode, and a CWDM filter in a single package. Optical diplexer 210 can be coupled to optical receiver 211, the combination of which can detect the optical signal, convert it to an electrical signal, and pass the signal on to cable modem 702.

Cable modem 702 can connect end user devices in the home 704 to the Internet. Cable modem 702 can be coupled to a router 214 for directing an Internet connection to a plurality of end user devices, including personal computer (PC) 215, medical services system 706, an alarm/security system 707. The router can be wired or wireless.

Cable modem 702 can be coupled to monitoring/control unit 703. Monitoring/control unit 703 can comprise optics monitoring and remote activation of video. Remote monitoring of each ONT can comprise monitoring received optical power, laser transmit power, temperature, and powering voltage levels. These parameters can assist the service provider to proactively predict trends and diagnose problems without a physical customer visit. Activation/deactivation of video service can be accomplished through the control interface.

Additionally, telephone service can be provided by coupling a telephone 219 to the cable modem 702 via a Plan Old Telephone System (POTS) or via a Voice Over IP (VOIP) system.

The optical receiver 211 can also transmit the signal to a set-top box 705 that is Ethernet, MOCA, or wireless return compatible. These set-top boxes represent alternative upstream options. A direct approach can use a set-top box Ethernet port and CAT5 cable to connect the upstream data signal to a home network for transport to the hub. MOCA (Multimedia over Coax Alliance) allows for transport of signals throughout the home using existing coax. The frequency of operation for MOCA is above the downstream frequency band. A MOCA receiver in the ONT can replace the previously described SWRD 216, and demodulate the signal to an Ethernet stream to be inserted with upstream data traffic. Alternatively, set-top upstream Ethernet traffic can use an in-home wireless standard to connect with a WiFi Router.

The signal can be provided to television (TV) 218. Set-top box 705 can also send an upstream signal, such as a request for a Video on Demand (VOD), to the cable modem 702 for upstream transmission. The set-top box 705 can comprise an Ethernet port and be coupled directly to the router 214 or the cable modem 702.

The ONT 701 can derive power from the home 704. Alternatively, it can be network powered through a separate outdoor power feed. In either case, battery backup can be used to power emergency telephone service during a power outage. In this example, the cable modem 702 can have battery backup power to maintain the POTS connection.

A signal can be sent from the cable modem 702 to a UMS optical transmitter 505 that can accept an electrical signal as input, process the signal, and use it to modulate an opto-electronic device, such as a laser contained within the optical diplexer 210. However, to avoid upstream collisions the laser can be placed under direct control of the cable modem 702 by coupling a laser driver 224 to the cable modem 702. Activation of the upstream laser relies on an output signal from the cable modem 702 activating the upstream laser via laser driver 224 in response. Thus, the optical system is placed under the direct control of a DOCSIS compliant system, such as CMTS 504 and cable modem 702. The upstream signal can be received by the WDM 208 and sent to an optical receiver such as UMS optical receiver 507, through a splitter such as splitter 506. By way of example, the Carrier to Noise Ratio (CNR) can be 48 dB downstream and >34 dB upstream.

The example system of FIG. 7 can utilize the upstream modulation schemes (UMS) previously described to overcome excessive losses in the upstream optical path.

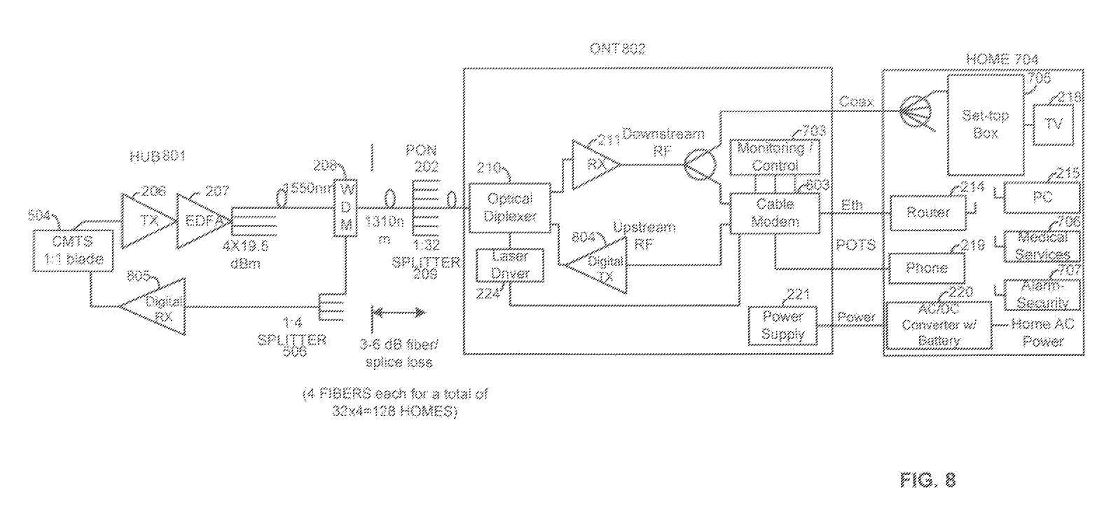

In another embodiment, illustrated in FIG. 8, provided is an example system for transporting a signal between a control point and a user device that utilizes direct control of an upstream laser and a digital upstream approach. The components of FIG. 8 are similar to those previously described, except the upstream technology is baseband digital. Where possible, like numbers represent the same elements throughout the figures. Components in common with FIG. 1A, FIG. 1B, FIG. 2, FIG. 5, and FIG. 7 that have been previously described will not be described in detail as they relate to FIG. 8. The example system can comprise a hub 801 which can comprise a CMTS 504, such as 1:1 CMTS blade 504. A 1:1 CMTS blade 504 allows for receiving one signal and transmitting one signal. The system can comprise an optical transmitter 206 and an optical amplifier 207, such as a four port TX/EDFA module with 18.3 dBm minimum output. The system can further comprise a WDM 208 coupled to the optical amplifier 207 and a PON 202 which can comprise splitter 209. Splitter 209 can be coupled to an optical diplexer 210. In the example system, downstream and upstream optical signals can be carried over the same fiber. An ONT 802 can comprise an optical diplexer. An optical diplexer 210 can comprise a laser, a photodiode, and a CWDM filter in a single package. Optical diplexer 210 can be coupled to optical receiver 211, the combination of which can detect the optical signal, convert it to an electrical signal, and pass the signal on to cable modem 803.

Cable modem 803 can connect end user devices in the home 704 to the Internet. Cable modem 803 can be coupled to a router 214 for directing an Internet connection to a plurality of end user devices, including personal computer (PC) 215, medical services system 706, an alarm/security system 707. The router can be wired or wireless.

Cable modem 803 can be coupled to monitoring/control unit 703. Monitoring/control unit 703 can comprise optics monitoring and remote activation of video. Remote monitoring of each ONT may consist of received optical power, laser transmit power, temperature, and powering voltage levels. These parameters can assist the service provider to proactively predict trends and diagnose problems without a physical customer visit. Activation/deactivation of video service can be accomplished through the control interface.

Additionally, telephone service can be provided by coupling a telephone 219 to the cable modem 803 via a Plan Old Telephone System (POTS) or via a Voice Over IP (VOIP) system.

The optical receiver 211 can also transmit the signal to a set-top box 705 that is Ethernet, MOCA, or wireless return compatible. These set-top boxes represent alternative upstream options. A direct approach would use a set-top box Ethernet port and CAT5 cable to connect the upsteam data signal to a home network for transport to the hub. MOCA (Multimedia over Coax Alliance) is a recent option for transport of signals throughout the home using existing coax. It's frequency of operation is above the downstream frequency band. A MOCA receiver in the ONT would replace the previously described SWRD, and demodulate the signal to an Ethernet stream to be inserted with upstream data traffic. Alternatively, the set-top upstream Ethernet traffic could use an in-home wireless standard to connect with the WiFi Router.

The signal can be provided to television (TV) 218. Set-top box 705 can also send an upstream signal, such as a request for a Video on Demand (VOD), to the cable modem 803 for upstream transmission. The set-top box 705 can comprise an Ethernet port and be coupled directly to the router 214 or the cable modem 803.

The ONT 802 can derive power from the home 704. Alternatively, it can be network powered through a separate outdoor power feed. In either case, battery backup can power emergency telephone service during a power outage. In this example, the cable modem 803 would have battery backup power to maintain the POTS connection.

A signal can be sent from the cable modem 803 to a digital optical transmitter 804 that can accept an electrical signal as input, digitize the signal, and use it to modulate an opto-electronic device, such as a laser contained within the optical diplexer 210. The laser can be configured to use baseband digital transmission in the upstream path. However, to avoid upstream collisions the laser can be placed under direct control of the cable modem 803 by coupling a laser driver 224 to the cable modem 803. Activation of the upstream laser relies on an output signal from the cable modem 803 activating the upstream laser via laser driver 224 in response. Thus, the optical system is placed under the direct control of a DOCSIS compliant system, such as CMTS 504 and cable modem 803. The upstream signal can be received by the WDM 208 and sent to a digital optical receiver such as digital optical receiver 805, through a splitter such as splitter 506. This receiver is a baseband digital receiver which uses a digital to analog converter to reconstruct the upstream RF signal. By way of example, the Carrier to Noise Ratio (CNR) can be 48 dB downstream and >34 dB upstream.

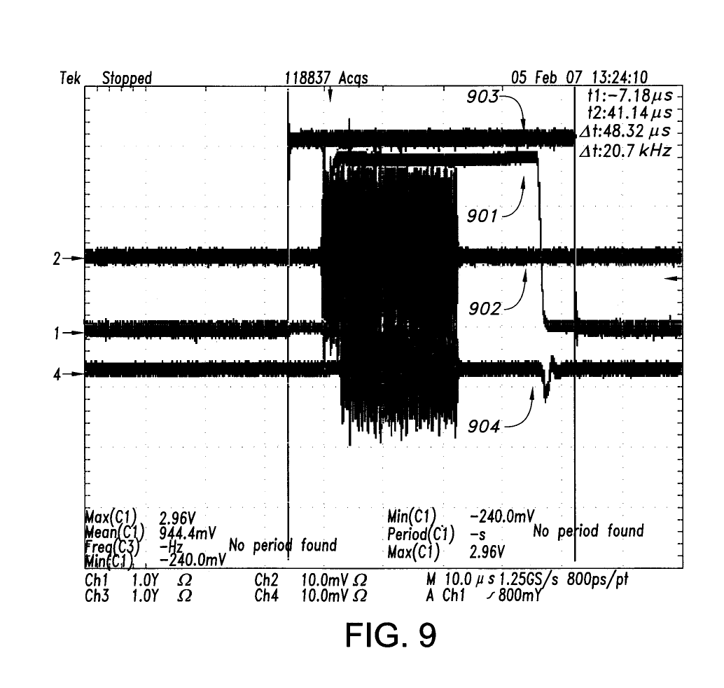

FIG. 9 illustrates the results of probing a DOCSIS Gateway to determine its compatibility with a direct control environment. The laser enable signal from the modem is shown at 903. The modem output signal to the RF laser is shown as a burst at 902. In this case, no signal is lost and there is no delay as previously described with the RF detection approach, also shown here for reference as 904 and 901 respectively.

### IV. Example Methods

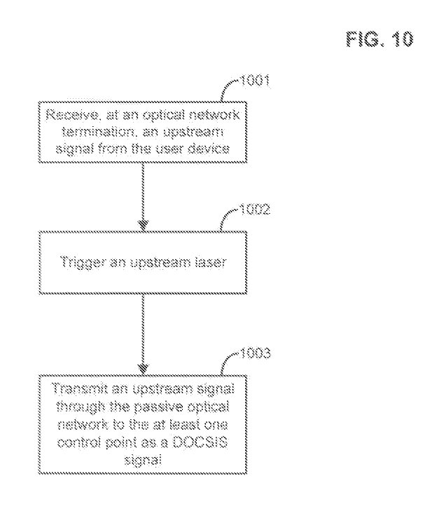

In one embodiment, illustrated in FIG. 10, provided are methods for transporting a signal between at least one control point and a user device, comprising receiving, at an optical network termination, an upstream signal from the user device at block 1001, triggering an upstream laser at block 1002, and transmitting an upstream signal through the passive optical network to the at least one control point as a DOCSIS signal at block 1003.

Triggering the upstream laser can comprise detecting the upstream signal with an RF detector and activating the upstream laser with the RF detector when the upstream signal is detected, and wherein the upstream signal is a DOCSIS signal.

In another embodiment, triggering the upstream laser with the upstream signal can comprise activating the upstream laser with a cable modem.

Transmitting the upstream signal through the passive optical network to the at least one control point can comprise a modulation scheme that allows reception in a low signal-to-noise environment. The modulation scheme can be, for example, frequency modulation, phase modulation, digital modulation, and the like.

Receiving an upstream signal from the user device can comprise transmitting a proprietary (for example, Digital Audio Visual Council (DAVIC)) signal from a proprietary signal generator to a single wire return device (SWRD), converting the proprietary signal to a data signal in the SWRD, transmitting the data signal from the SWRD to a cable modem, and converting the data signal to a DOCSIS signal.

Receiving an upstream signal from the user device can comprise transmitting a data signal from a set-top box to a cable modem and converting the data signal to a DOCSIS signal in the cable modem.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as examples only, with a true scope and spirit being indicated by the following claims.

1. A system for transporting a signal between at least one control point and a user device, comprising:
a passive optical network operatively coupled to the at least one control point; and
an optical network termination operatively coupled to the passive optical network and operatively coupled to the user device,
wherein the optical network termination comprises an upstream laser and an upstream laser driver coupled to the upstream laser and an upstream laser driver trigger, the upstream laser driver trigger is configured to activate the upstream laser driver and initiate an upstream signal in compliance with Data Over Cable Service Interface Specification (DOCSIS) from the user device to the at least one control point.

2. The system of claim 1, wherein the upstream laser driver trigger comprises an RF detector configured to detect an incoming upstream electrical signal from the user device and activate the upstream laser driver.

3. The system of claim 2, wherein the system is configured to utilize a modulation scheme that allows reception in a low signal-to-noise environment.

4. The system of claim 3, wherein the system is configured to utilize at least one of frequency modulation, phase modulation, and digital modulation.

5. The system of claim 1, wherein the upstream laser driver trigger comprises a signal from a cable modem configured to activate the upstream laser driver.

6. The system of claim 1, wherein the user device comprises a proprietary signal generator coupled to a single wire return device (SWRD) coupled to a cable modem, wherein a proprietary signal is transmitted to the SWRD, converted into a data signal, transmitted to the cable modem, and sent upstream to the at least one control point.

7. The system of claim 6, wherein the proprietary signal generator is a set-top box.

8. The system of claim 1, wherein the user device comprises a set-top box coupled to a cable modem, wherein a data signal is transmitted to the cable modem and sent upstream to the at least one control point.

9. The system of claim 1, wherein the signal is comprised of at least one of a video signal, a voice signal, and a data signal.

10. The system of claim 1, wherein the signal is a downstream signal and the at least one control point transmits the downstream signal optically according to DOCSIS.

11. The system of claim 1, wherein the signal is an upstream signal and the user device transmits the upstream signal to the control point according to DOCSIS.

12. The system of claim 1, wherein the user device is contained within the optical network termination.

13. A method for transporting a signal between at least one control point and a user device, comprising:
receiving, at an optical network termination, an upstream signal from the user device;
triggering an upstream laser; and
transmitting an upstream signal through the passive optical network to the at least one control point as a DOCSIS signal.

14. The method of claim 13, wherein triggering the upstream laser comprises:
detecting the upstream signal with an RF detector; and
activating the upstream laser with the RF detector when the upstream signal is detected, and wherein the upstream signal is a DOCSIS signal.

15. The method of claim 13, wherein triggering the upstream laser with the upstream signal comprises activating the upstream laser with a cable modem.

16. The method of claim 13, wherein transmitting the upstream signal through the passive optical network to the at least one control point comprises a modulation scheme that allows reception in a low signal-to-noise environment.

17. The method of claim 16, wherein the scheme is at least one of frequency modulation, phase modulation, and digital modulation.

18. The method of claim 13, wherein receiving an upstream signal from the user device comprises:
transmitting a proprietary signal from a proprietary signal generator to a SWRD,
converting the proprietary signal to a data signal in the SWRD;
transmitting the data signal from the SWRD to a cable modem; and
converting the data signal to a DOCSIS signal.

19. The method of claim 13, wherein receiving an upstream signal from the user device comprises:
transmitting a data signal from a set-top box to a cable modem; and
converting the data signal to a DOCSIS signal in the cable modem.

20. An optical network termination adapted to couple a user device to at least one control point over a passive optical network, comprising:
an upstream laser; and
an upstream laser driver trigger coupled to the upstream laser, wherein the upstream laser driver trigger is configured to activate the upstream laser and initiate an upstream signal in compliance with Data Over Cable Service Interface Specification (DOCSIS) from the user device to the at least one control point.
